(19) United States
(12) Patent Application Publication
(10) Pub. No.: US 2006/0204214 A1
(43) Pub. Date: Sep. 14, 2006

(54) Picture line audio augmentation

(75) Inventors: Mehul Y. Shah, Redmond, WA (US); Dongmei Zhang, Bellevue, WA (US); Vladimir Rovinsky, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/079,151

(22) Filed: Mar. 14, 2005

(51) Int. Cl. G11B 27/00

(52) U.S. Cl. 386/54

(57) ABSTRACT

The subject invention provides a system and/or a method that facilitates creating an authored video with audio applied to at least one image/video segment within the authored video. An audio enhancement component can apply audio to at least one image/video segment, wherein an audio segment begins with a display of the image/video segment (e.g., an instance of displaying the image or video segment within the authored video). A segment-line can be utilized to provide audio to the image/video segment(s) within the authored video, wherein the segment-line can be a sequence of image/video segments chronologically ordered based upon a start and an end of the image/video clip.

### CROSS-REFERENCE TO RELATED APPLICATION(S)

This application is related to U.S. Pat. No. 6,803,925 filed on Sep. 6, 2001 and entitled “ASSEMBLING VERBAL NARRATION FOR DIGITAL DISPLAY IMAGES,” and co-pending U.S. patent application Ser. No. 10/924,382 filed on Aug. 23, 2004 and entitled “PHOTOSTORY FOR SMART PHONES AND BLOGGING (CREATING AND SHARING PHOTO SLIDE SHOWS USING CELLULAR PHONES).” This application is also related to co-pending U.S. patent application Ser. No. 10/959,385 filed on Oct. 6, 2004 and entitled “CREATION OF IMAGE BASED VIDEO USING STEP-IMAGES,” co-pending U.S. patent application Ser. No. ______ (Docket No. MS310524.01), Ser. No. ______ (Docket No. MS310526.01), Ser. No.______ (Docket No. MS310560.01), and Ser. No. ______ (Docket No. MS310939.01), titled “______,” “______,” “______,” and “______,” filed on ______, ______, ______, and ______, respectively.

### TECHNICAL FIELD

The present invention generally relates to computer systems and more particularly to systems and/or methods that facilitate applying audio to a video comprised of one or more segments—each segment comprised of an image or a video clip.

### BACKGROUND OF THE INVENTION

There is an increasing use of digital photography based upon decreased size and cost of digital cameras and increased availability, usability, and resolution. Manufacturers and the like continuously strive to provide smaller electronics to satisfy consumer demands associated with carrying, storing, and using such electronic devices. Based upon the above, digital photography has grown and proven to be a profitable market for both electronics and software.

A user first experiences the overwhelming benefits of digital photography upon capturing a digital image. While conventional print photography forces the photographer to wait until development of expensive film to view a print, a digital image in digital photography can be viewed within sub-seconds by utilizing a thumbnail image and/or viewing port on a digital camera. Additionally, images can be deleted or saved based upon user preference, thereby allowing efficient use of limited image storage space. In general, digital photography provides a more efficient experience in photography.

Editing techniques available for a digital image are vast and numerous with limitations being only the editor's imagination. For example, a digital image can be edited using techniques such as crop, resize, blur, sharpen, contrast, brightness, gamma, transparency, rotate, emboss, red-eye, texture, draw tools (e.g., a fill, a pen, add a circle, add a box), an insertion of text, etc. In contrast, conventional print photography merely enables the developer to control developing variables such as exposure time, light strength, type of light-sensitive paper, and various light filters. Moreover, such conventional print photography techniques are expensive whereas digital photography software is becoming more common on computers. Digital cameras available to consumers today also contain capability to record short video segments in digital format.

Digital photography also facilitates sharing of images. Once stored, images that are shared with another can accompany a story (e.g., a verbal narration) and/or physical presentation of such images. Regarding conventional print photographs, sharing options are limited to picture albums, which entail a variety of complications involving organization, storage, and accessibility. Moreover, physical presence of the album is a typical manner in which to share print photographs with another.

In view of the above benefits associated with digital photography and deficiencies of traditional print photography, digital images and albums have increasingly replaced conventional print photographs and albums. In particular, software may be used to compose a video from the digital video segments and images. Transitions may be added between the image/video segments and panning/zooming motion may be added to the images to provide an aesthetically pleasing experience. Ability to add voice narration, text captions and titles, augment the images/video segments with artistic photo effects can further enhance presentational value of images/video segments. Such an authored video provides a convenient and efficient technique for sharing photo and video content. Adding background music to such an authored video would complete the video experience.

With the vast sudden exposure to digital photography and digital cameras, the majority of digital camera users are unfamiliar with the plethora of applications, software, techniques, and systems dedicated to generating image-based video presentations from images/video segments. Furthermore, a user typically viewed and/or prints with little or no delay. Thus, in general, camera users prefer quick and easy image presentation capabilities with high quality and/or aesthetically pleasing features. Traditional image presentation applications and/or software require vast computer knowledge and experience in digital photography and video editing, (based upon the overwhelming consumer consumption) Users are unable to comprehend and/or unable to dedicate the necessary time to self-educate themselves in this particular realm.

In view of the above, there is a need to improve upon and/or provide systems and/or methods relating to video authoring that facilitate applying audio to at least one image or video clip in an intuitive and predictable fashion.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to systems and/or methods that facilitate applying audio to an image or video segment within an authored video. An audio enhancement component can apply audio to at least one image and/or video segment within the authored video, wherein an audio sequence begins with display of the image (e.g., an instance of displaying the image within the image-based video) or with display of the video clip. For example, audio can be provided to the image based at least in part upon a segment line, which can be a sequence of image and/or video segments that are chronologically ordered as a function of a start and an end of the segment. The foregoing enables a user to easily add background audio to the video comprised of image and/or video segments.

In accordance with one aspect of the subject invention, the audio enhancement component can include a music component that can create and/or obtain one or more audio segments to be applied to the authored video. Each audio segment can span over one or more of the image/video segments. Each audio segment can be created audio, existing audio, and/or a combination thereof. The music component can create an audio segment by utilizing various combinations of at least one of a beat, a tempo, an intensity, a selection of an instrument, a genre, a style, . . . . The audio segment can also convey a mood for the authored video. For instance, fast, intense, and upbeat audio can convey an adventurous mood. Existing audio can be located on a remote system, a data store, a laptop, the Internet, a personal computer, a server, . . . . Additionally, the music component can include a normalizer component to provide normalization to a volume level relative to other audio segments. The normalizer component can provide the normalization as an automatic feature, a manual feature, and/or any combination thereof. Furthermore, the music component can provide a fade component to employ a fade technique to audio. The fade component can incorporate a fade-in for an audio at the start of the audio segment and/or a fade-out for an audio at the end of the audio segment.

In accordance with another aspect of the subject invention, the audio enhancement component can include an editor component that can allow a user to edit the authored video, a related image/video segment, and/or audio segment. The editor component can allow deletion of audio segments, addition of audio segments, editing of audio segment (recomposing of the created segment, adjusting duration of the created and existing segments and playback start location within the existing music segment), deletion of an image segment, addition of an image segment, editing of panning/zooming movement of image within an image segment, editing duration of an image segment, addition of video segments, deletion of video segments as well as specifying video transitions between the image/video segments and specifying audio transitions between the audio segments. It is to be appreciated that any suitable operation by the editor component can be based upon the chronologically, sequenced segments ordered based upon a start and an end of the image and/or video clip.

In accordance with one aspect of the subject invention, a user interface can be employed to facilitate creating audio for the authored video and/or applying such audio to the image/video segment within the authored video. The user interface for creating audio can allow a user to select from a variety of options to create audio tailored to the user preferences and/or to convey a particular mood. Moreover, the user interface for applying audio can include a thumbnail to represent the image/video segments within the authored video, wherein the user can select and preview the image/video segment with an associated audio.

The following description and the annexed drawings set forth in detail certain illustrative aspects of the invention. These aspects are indicative, however, of but a few of the various ways in which the principles of the invention may be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a block diagram of an exemplary system that facilitates applying audio to an authored video composed of image/video segments.

FIG. 2 illustrates a block diagram of an exemplary system that facilitates creating and/or applying audio to an image/video segment within an authored video.

FIG. 3 illustrates a block diagram of an exemplary system that facilitates generating a specific tailored audio segment for an image/video segment.

FIG. 4 illustrates a block diagram of an exemplary system that facilitates creating and/or applying audio segment to an image/video segment within an authored video.

FIG. 5 illustrates a block diagram of an exemplary system that facilitates creating and/or applying audio to an image/video segment within an authored video.

FIG. 6 illustrates an interface to create audio for an authored video.

FIG. 7 illustrates an interface to apply audio to an authored video.

FIG. 8 illustrates a method to add an audio segment to an authored video without a soundtrack.

FIG. 9 illustrates a method to add an audio segment to an authored video demonstrating the creation of an anchor image/video segment.

FIG. 10 illustrates a method to add an audio segment to an authored video that has existing soundtrack without replacing any portion of the soundtrack.

FIG. 11 illustrates a method to add an audio segment to an authored video that has existing soundtrack replacing an existing portion of the soundtrack with a longer audio segment.

FIG. 12 illustrates a method to add an audio segment to an authored video that has existing soundtrack replacing an existing portion of the soundtrack with a shorter audio segment.

FIG. 13 illustrates a method to delete an audio segment from an authored video that has existing soundtrack.

FIG. 14 illustrates a method to add an image/video segment to an authored video that has existing soundtrack.

FIG. 15 illustrates a method to delete/remove an image/video segment from an authored video that has existing soundtrack.

FIG. 16 illustrates a method to move an image/video segment within an authored video that has existing soundtrack.

FIG. 17 illustrates a methodology that facilitates applying audio to an authored video.

FIG. 18 illustrates a methodology that facilitates applying audio to an authored video.

FIG. 19 illustrates an exemplary networking environment, wherein the novel aspects of the subject invention can be employed.

FIG. 20 illustrates an exemplary operating environment that can be employed in accordance with the subject invention.

### DESCRIPTION OF THE INVENTION

As utilized in this application, terms “component,” “system,” “generator,” “store,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

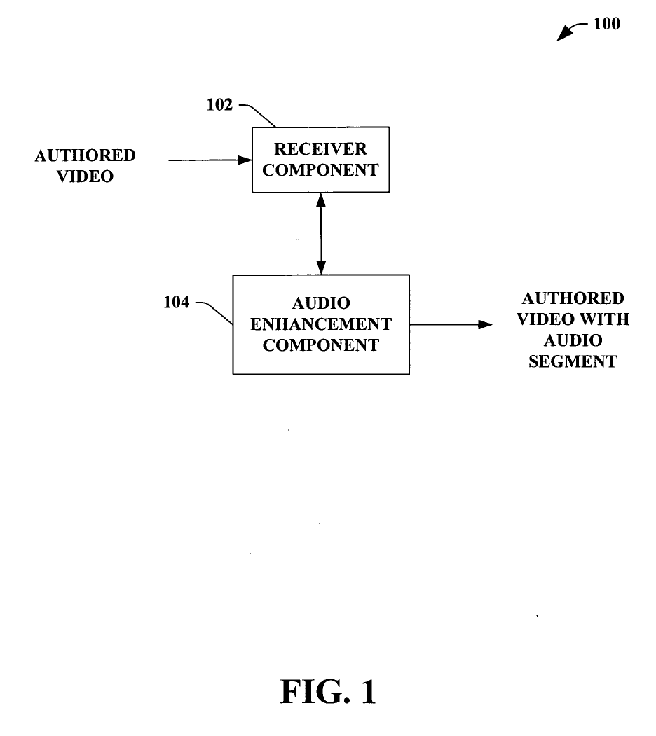

Now turning to the figures, FIG. 1 illustrates a system 100 that facilitates applying audio to an authored video. An audio enhancement component 104 can apply audio to at least one image/video segment within the authored video such that an audio sequence begins with display of the image/video segment (e.g., an instance of displaying the image or video segment within the authored video). For example, a segment-line can be utilized as a basis to provide audio to the image/video segment(s) related to the authored video (e.g., a video presentation of video clips and still images that have panning/zooming motion associated thereto giving an impression of a video). The segment-line can be a sequence of images and/or video clips that are chronologically ordered based upon a start and an end of displaying the image or video clip. For example, an authored video can include four image segments, in which a user can apply audio. The audio enhancement component 104 can provide audio to the image segments based upon the display of the image segment. For instance, a sound clip can be applied to the image segment, wherein the sound clip is played upon a first display of such image segment within the authored video. A user can utilize the audio enhancement component 104 to apply audio starting at a third image segment rather than specifying a time for the audio to begin. The audio can be applied based upon the image or video segment position by utilizing the segment-line, while conventionally audio is applied based upon the timeline. It is also to be appreciated that the audio can be of any suitable format including a WAV, an MP3, an MP4, an AVI, an MPEG, a WMA, . . . . In contrast, conventional applications and/or systems typically utilize a timeline to provide audio during video editing. Using a segment-line instead of a timeline makes video editing easier to perform because in most cases, the audio start and end is synchronized with the start/end of the corresponding image/video segment.

The audio enhancement component 104 can incorporate audio into the authored video regardless of its origin. In accordance with one aspect of the subject invention, the audio enhancement component 104 can generate audio for the image/video segment to provide a more aesthetically pleasing presentation. Additionally, the audio enhancement component 104 can download and/or import audio from a remote location and/or a disparate system. For instance, the audio enhancement component 104 can receive audio via the Internet, a data store, a website, a remote computer, a portable digital file device, an MP3 device, etc.

The system 100 further includes a receiver component 102, which provides various adapters, connectors, channels, communication paths, etc. to integrate the audio enhancement component 104 into virtually any system. It is to be appreciated that although the receiver component 102 is a separate component from the audio enhancement component 104, such implementation is not so limited. The receiver component 102 can be incorporated into the audio enhancement component 104 to receive video clip(s), image(s), and/or audio in relation to the system 100.

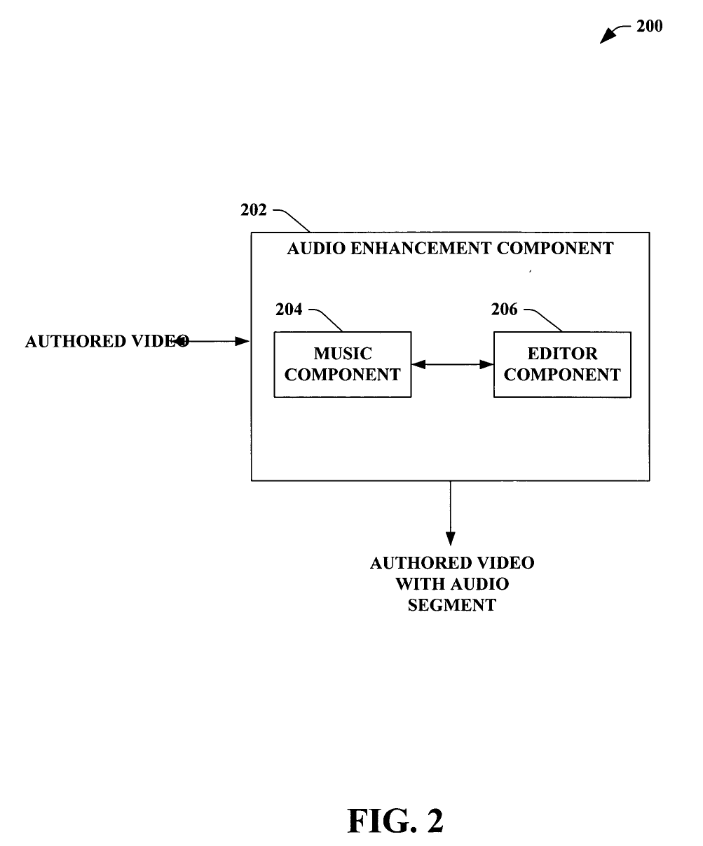

FIG. 2 illustrates a system 200 that facilitates creating and/or applying audio to an authored video based at least in part upon a segment-line. An audio enhancement component 202 can receive the authored video including one or more image/video segments to which a user can apply audio. Applying audio can be based at least in part upon the segment-line (e.g., a sequence of images and/or video clips chronologically ordered based upon a start and an end of the image/video clip). For instance, the user can incorporate audio to the authored video starting at a display of a second image/video segment, rather than having to calculate a specific time at which the second image/video segment is displayed. The audio can be, but is not limited to, an audio clip providing an aesthetically pleasing presentation in conjunction with the authored video. It is to be appreciated that the audio can be of any suitable format including a WAV, an MP3, an MP4, an AVI, an MPEG, a WMA, . . . .

The audio enhancement component 202 can include a music component 204 that can create audio and/or import/download audio for incorporating into the authored video. The music component 204 can generate audio and/or an audio effect to convey a desired mood such as adventurous, anxious, sentimental, happy, excited, nervous, etc. In one example, a fast, up-beat audio can be utilized to portray an adventurous atmosphere relating to a sky-diving authored video. A unique feature of such generated audio segment is that if the temporal duration of the audio segment is increased or decreased as a result of editing operations (such as adding/removing image/video segments or adding/removing other audio segments), the affected audio segment can be regenerated so as to fit precisely the required duration so that it always gives the perception of being a complete musical composition with a natural beginning and end.

In addition, the music component 204 can download/import an existing audio. For instance, the user can utilize an existing song for the authored video, which can be stored on a laptop. It is to be appreciated and understood that the audio enhancement component 202 can utilize created audio, downloaded audio, and/or any combination thereof to apply audio to the authored video. For example, a user can create an audio segment to apply for the first image/video segment, and apply an existing audio segment for the second image/video segment.

The audio enhancement component 202 further utilizes an editor component 206 to edit and/or manipulate the image-based video in relation to audio. The editor component 206 can provide, but is not limited to, addition of an audio segment, deletion of an audio segment, editing of audio segment (recomposing of the created segment, adjusting duration of the created and existing segments and playback start location within the existing music segment), addition of an image segment, deletion of an image segment, addition of a video segment, deletion of a video segment, movement of an image/video segment, adjusting the duration of an image/video segment. It is to be appreciated and understood that these operations utilize the segment-line. In other words, any suitable edit by the editor component 206 is based upon the sequence of image/video segments chronologically ordered based upon the start and the end of the segment. For example, audio can be added to an authored video that has five slides (e.g., 5 image and/or video segments). The audio can be added based upon the start (e.g., the display) of the second image/video segment and played until the audio has ended (e.g., an end of a fourth image/video segment). A user can utilize the start and the end of displaying the image/video segment to determine a beginning and/or an end of audio.

In particular, the editor component 206 can utilize a set of guidelines and/or rules to define a placement of an audio segment in the image/video segment-line to form a soundtrack (e.g., the audio) for the authored video. It is to be appreciated that the image/video segment at which the audio segment begins is an anchor image/video segment. For example, the audio segment can begin with a third image/video segment of a ten image/video segment based authored video. The third image/video segment can be referred to as the anchor image/video segment for the audio segment. Additionally, the audio segment for the third image/video segment can begin to play when the third image/video becomes visible. It is to be appreciated that if a display technique that does not display the image/video in its entirety is utilized between subsequent images/videos (e.g., a cross-fade), the audio segment can start playing when the anchor image/video segment has a percentage displayed (e.g., 50%). The editor component 206 can utilize a full length of the audio segment and associate such audio segment over as many image/video segments as possible. For example, an authored video can have five image/video segments, where each image/video segment is one minute in length. A four-minute audio segment can be applied (e.g., anchored, start to play) to the first image/video segment, wherein the audio segment will be played until it has ended (e.g., until the end of the fourth image/video segment).

The editor component 206 can extend the audio segment over image/video segments until another anchor image/video segment is encountered and/or audio segment ends and/or the authored video is complete. Following the previous example, the four minute audio segment can be played until a new anchor image/video segment at a third segment is encountered (e.g., the user adds audio to start at the display of the third image/video segment). However, the audio segment can end in a period that is shorter than the display of the anchor image/video segment. In this scenario, the editor component 206 can reduce the duration of displaying the image/video segment to match the duration of the audio segment, edit the audio segment to make it play as long as the anchor image/video segment, and/or add another audio segment to play for the rest of the duration of the image/video segment. It is to be appreciated that the editor component 206 can provide automatic adjustment, manual adjustment, and/or a combination thereof to handle the scenario of the audio segment ending before the period of displaying the image/video segment.

Furthermore, the editor component 206 can delete audio from the authored video. The deletion of the audio segment and/or a complete soundtrack (e.g. the audio for an entire authored video) can be based on the segment-line. For example, adding a new audio segment to an anchor image/video segment can delete the previous audio segment for the anchor image/video segment and replace it with the new audio segment. Thus, the anchor image/video segment will play the new audio segment when it is displayed. In another example, the editor component 206 can delete the audio segment when an anchor image/video segment is deleted. When the anchor image/video segment is removed from the authored video, the audio segment associated to such image/video segment is also removed.

It is to be appreciated that the editor component 206 can invoke a user interface (not shown) to facilitate editing the authored video. For instance, the user interface can provide a pictorial representation of the image/video segments that comprise the authored video, wherein a user can select a specific image/video segment to edit, manipulate, add and/or apply audio. Thus, the user can select one of the image/video segments and opt to clear audio associated thereto. The user interface can invoke, for example, a button, a slider, a text field, etc. to incorporate the user's interaction with the editor component 206. Although the user interface can be invoked by the editor component 206, the subject invention is not so limited; the editor component 206 can incorporate an application programming interface (API), a graphic user interface (GUI), . . . .

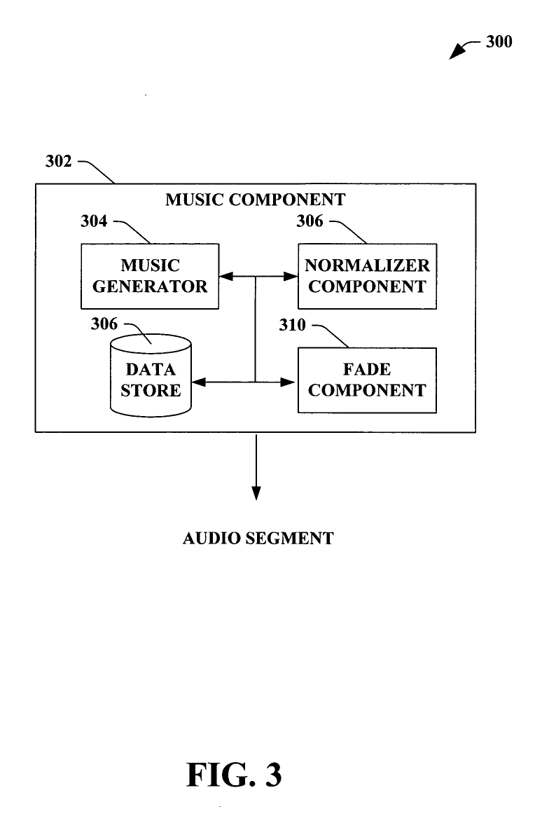

FIG. 3 illustrates a system 300 that facilitates creating and/or downloading audio that can be applied to an authored video. A music component 302 can create audio and/or download existing audio for incorporating into the authored video. In particular, a music generator 304 can create audio tailored to the authored video based at least in part upon a user's preference. The music generator 304 can implement audio with an audio sample and/or an audio effect. For example, a synthesized wave sound from a digital sample can be stored in software, a data store, . . . to be utilized to create audio. The music generator 304 can also utilize a set of pre-determined sounds to simulate various genres of music (e.g., Jazz, Classical, Rock, Reggae, Polka, Disco, . . . ). The simulation of the various genres of music can be based upon, tempo, base-beat, number of instruments, type of instruments, etc. In other words, the music generator 304 can create an audio composition from the set of pre-determined sounds.

Furthermore, the music component 302 can utilize a data store 306 to store audio such as an audio clip, an audio sample, a song, a beat, etc. of any suitable format. The data store 306 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 306 of the subject systems and methods is intended to comprise, without being limited to, these and any other suitable types of memory. In addition, it is to be appreciated that the data store 306 can be a server and/or database.

The music component 302 can also include a normalizer component 308 that can provide volume manipulation and/or adjustment. The normalizer component 308 can normalize a volume level for the audio segment to allow a constant volume level across several audio segments used in the authored video or to maintain a certain ratio between volume levels of the audio segment associated with the same portion of the segment-line as the audio segment. The normalizer component 308 can provide a volume manipulation and/or adjustment automatically, manually, and/or a combination thereof. For example, a user can manually select volume levels to be played with the authored video such that a first audio segment can play at a first percentage of its original volume, while a second audio segment can be played at a second percentage of its original volume such that when the first and second audio segments are incorporated one after another in the authored video, the listener perceives a constant audio volume level across the two audio segments over the duration of the authored video.

A fade component 310 can be included with the system 300 to apply a fade-in for the audio segment. It is to be appreciated that the fade component 310 can be utilized with created audio and/or existing audio. The fade-in (e.g., from a first volume level to a second volume level, wherein the second volume level is greater than the first) can be applied at the start of the audio segment. It is to be appreciated that if no audio is associated to the image preceding the anchor image for the audio, the audio can start at any level determined by the user and/or the music component 302.

The fade component 310 can also apply a fade-out at the end of the audio segment for the authored video. The fade-out can be applied to created audio and/or existing audio, wherein audio is decreased from a first volume to a second volume, where the first volume is greater than the second volume. With having a fade-out and fade-in, the listener is not subjected to a jarring experience at the end of the first audio segment and the beginning of the second audio segment when the first and second audio segments are inserted back-to-back in the authored video.

It is to be appreciated that the music component 302 can utilize the fade component 310 with a video transition. The video transition is applied between subsequent image/video segments such as, but not limited to, a wipe, a fade, a cross-fade, an explode, an implode, a matrix wipe, a push, a dissolve, and a checker. It is to be understood that any and all video transitions can be employed in conjunction with the subject invention. The music component 302 can apply the audio fade in cohesion with the video transition. The music component 302 can implement audio such that adjacent audio is not played simultaneously. For instance, a first audio can end at a zero volume and a second audio can start from a zero volume.

The fade component can also be replaced by an audio transition component wherein instead of fading out the first audio segment and fading in the subsequent second audio segment, the audio transition component applies some beat-matching technique to generate intermediate beats and provides a smooth perception of transition from the first audio segment to the second audio segment.

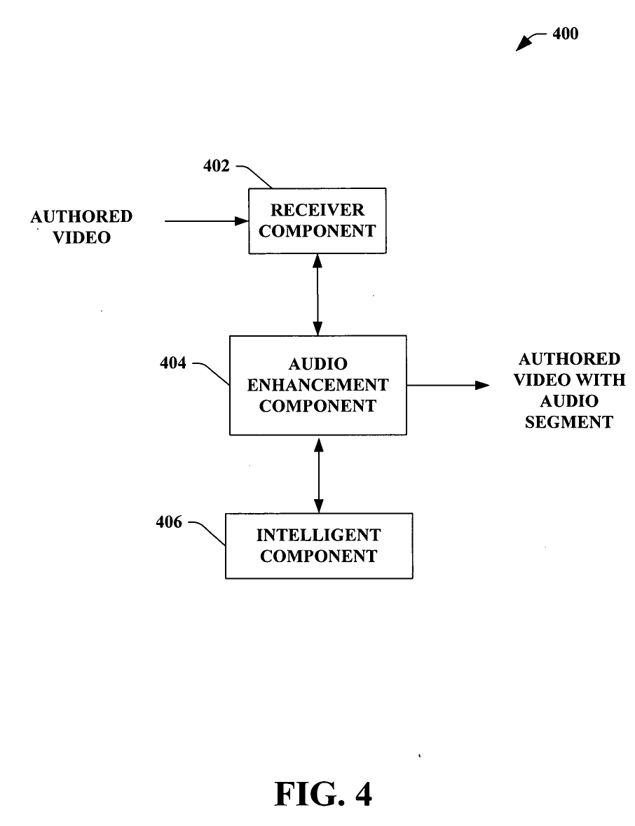

FIG. 4 illustrates a system 400 that employs intelligence to facilitate applying and/or creating audio for an authored video. The system 400 includes an audio enhancement component 404, and a receiver component 402. As described in detail above the audio enhancement component 404 can apply and/or create audio associated to at least one image or video clip within the authored video utilizing a segment-line. The audio enhancement component 404 can provide audio to the authored video regardless of a format, a size, a file size, and/or a particular audio utilized. Furthermore, the audio enhancement component 404 can be utilized to provide a respective audio to a specific image/video segment or for a plurality of image/video segments incorporated within the authored video.

The system 400 further includes an intelligent component 406 to facilitate providing, creating, and/or applying audio. For example, the intelligent component 406 can be utilized to facilitate creating and/or incorporating audio with the image or video segment within the authored video. For example, various audio can be one of many file formats. The intelligent component 406 can determine an audio format, convert the audio, manipulate the audio, and/or import the audio without a format change. In another example, the intelligent component 406 can infer the audio to be applied to the authored video by utilizing a user history and/or a previous authored video(s).

It is to be understood that the intelligent component 406 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the subject invention.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

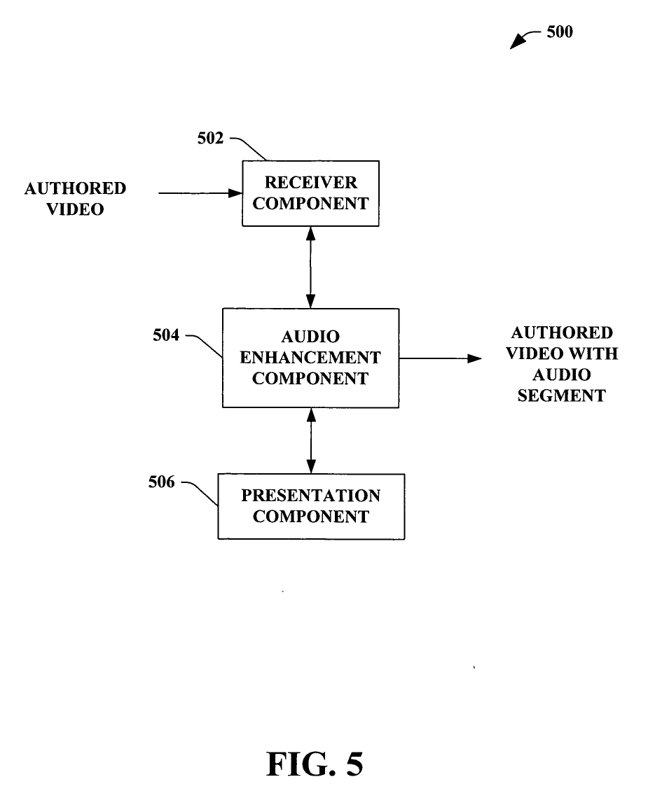

FIG. 5 illustrates a system 500 that facilitates creating and/or applying audio to an authored video by utilizing a segment-line. An audio enhancement component 504 can receive the authored video and generate and/or apply audio to the authored video to provide an aesthetically pleasing presentation. A receiver component 502 can receive the authored video without audio, transmit the authored video with audio, and/or provide other communications associated to the audio enhancement component 504. In addition, the audio enhancement component 504 can interact with a presentation component 506. The presentation component 506 can provide various types of user interfaces to facilitate interaction between a user and any component coupled to the receiver component 502, and/or the audio enhancement component 504. As depicted, the presentation component 506 is a separate entity that is coupled to the audio enhancement component 504. However, it is to be appreciated that the presentation component 506 and/or similar presentation components can be incorporated into the audio enhancement component 504, and/or a stand-alone unit.

The presentation component 506 can provide one or more graphical user interfaces (GUIs), command line interfaces, and the like. For example, a GUI can be rendered that provides a user with a region or means to load, import, read, etc. data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such vertical and/or horizontal scroll bars for navigation and toolbar buttons to determine whether a region will be viewable can be employed. For example, the user can interact with one or more of the components coupled to the audio enhancement component 504.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the invention is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

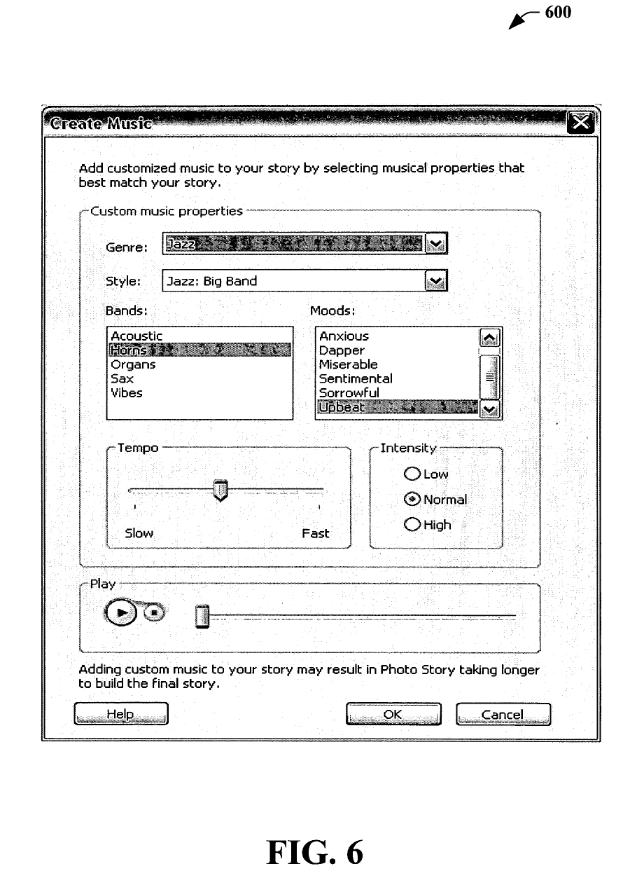

Briefly referring to FIG. 6, a user interface 600 is illustrated that can be utilized in accordance with the subject invention. The user interface 600 can be utilized to allow a user to create and/or generate audio for authored video. The user interface 600 can include a genre, a style, an instrument selection, a mood, a tempo, and an intensity from which the user can select to create audio. In addition, the user interface 600 can provide a preview by allowing the user to play the audio created. It is to be appreciated that the user interface 600 can provide various user inputs with a text field, a pull-down menu, and/or a click-able selection.

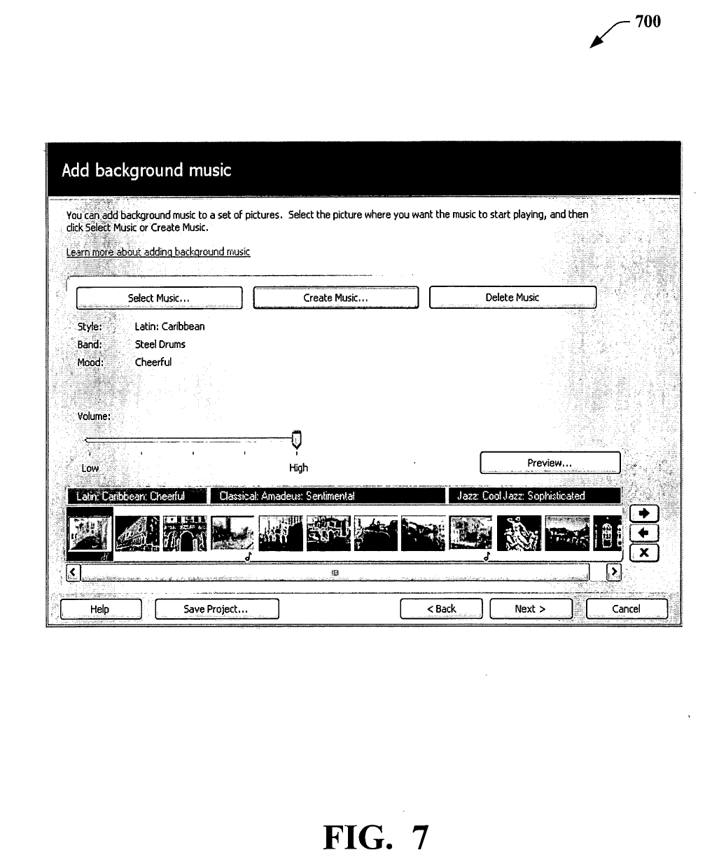

FIG. 7 is a user interface 700 that can assist a user with applying and/or creating audio for an image-based video. The user interface 700 can provide options for the user to select music, create music, and/or delete music. Additionally, the user interface 700 can contain one or more thumbnail images within the authored video to facilitate associating audio to the image. The user can also preview the authored video with a preview button. Furthermore, the user interface 700 can provide additional options such as, but are not limited to, a save of a project to facilitate subsequent editing of the authored video, a volume level for the audio segment, volume normalization control, help content link, a cancel option, a web link, . . . .

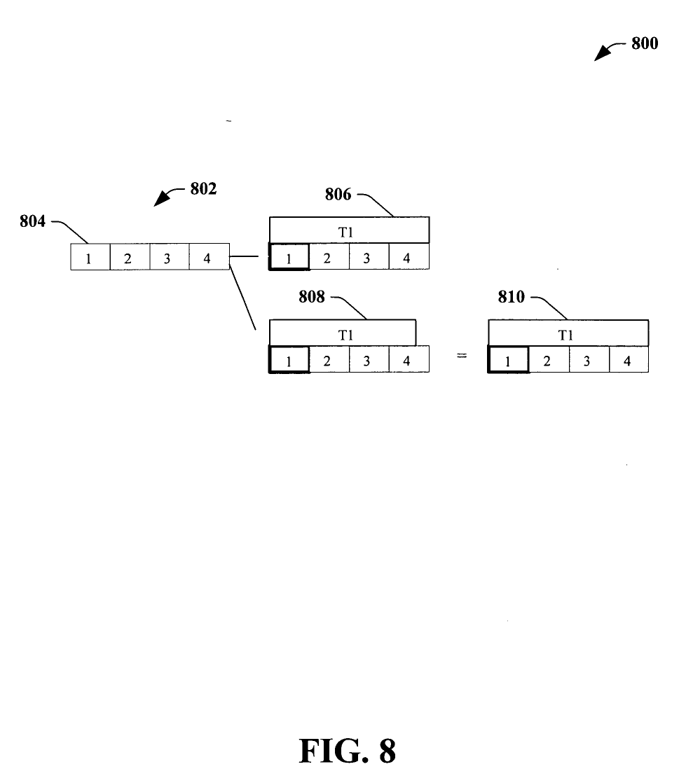

FIGS. 8-18 illustrate methodologies in accordance with the subject invention. For simplicity of explanation, the methodologies are depicted and described as a series of acts. It is to be understood and appreciated that the subject invention is not limited by the acts illustrated and/or by the order of acts, for example acts can occur in various orders and/or concurrently, and with other acts not presented and described herein. Furthermore, not all illustrated acts may be required to implement the methodologies in accordance with the subject invention. In addition, those skilled in the art will understand and appreciate that the methodologies could alternatively be represented as a series of interrelated states via a state diagram or events.

FIG. 8 illustrates a methodology 800 that facilitates adding audio to an image and/or a video segment within an authored video. A group of four image/video segments 802 can have audio applied based upon a segment-line. An audio segment 806 (“T1”) can be added to a first image/video segment (depicted as image/video segment number one) providing audio for a duration of the audio segment 806. In one example, the audio track can end before an end of displaying a last image/video segment within the authored video (e.g., the fourth image). An audio segment 808 does not extend to the end of displaying the last image/video segment, yet a user can edit the duration of the audio track, add additional blank audio, decrease the duration of display of the last image/video segment, etc. in order to have the audio extend to the end of displaying the last image/video segment as seen by reference numeral 810. It is to be appreciated that a rule can be implemented by the audio enhancement component to automatically end (e.g., with or without fadeout) playback of audio segment 808 at the end of the display of image/video segment three of the pictured segment-line or present appropriate UI that can allow user input to be received on desirability of automatic duration adjustment of the display duration of the images/video clips one to four of the pictured segment-line. For the purpose of the further discussion of the of the subject invention, it can be assumed that the situation of audio segment duration not extending to the end of the duration of the last image/video segment it overlaps can be successfully resolved in a multitude of ways. Therefore, in the discussion of FIGS. 8-16, it will be assumed that the end of an audio segment always extends to the end of the last image/video segment it overlaps as seen by reference numeral 810.

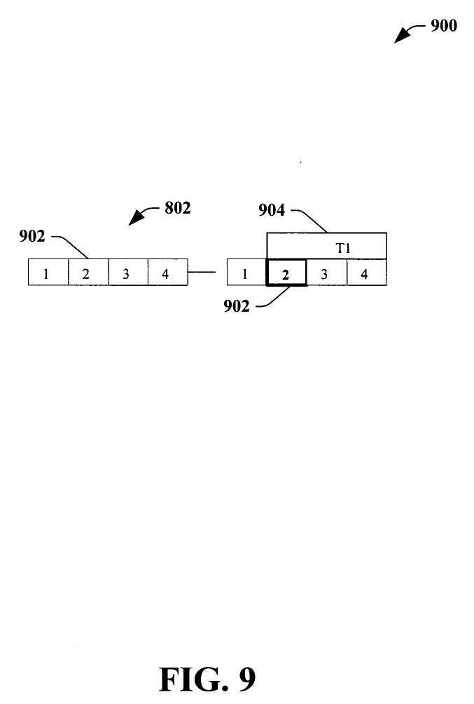

FIG. 9 illustrates a methodology 900 that facilitates adding audio to an image and/or a video segment within an authored video. The group of four image/video segments 802 can have audio added based upon a segment-line. For example, a user can add audio to start at a beginning of a display of a second image/video segment 902. An audio segment 904 (“T1”) can be played at a percentage of display for the second image/video segment 902 and stop at a conclusion of an audio length and/or a percentage of the audio length. It is to be appreciated that the second image/video segment can be referred to as an anchor image/video segment since the audio is to start at the second image/video segment. An anchor image/video segment is depicted on the diagram by a bold frame around it. This technique is used in all depictions of the segment-line diagrams in FIGS. 8-16.

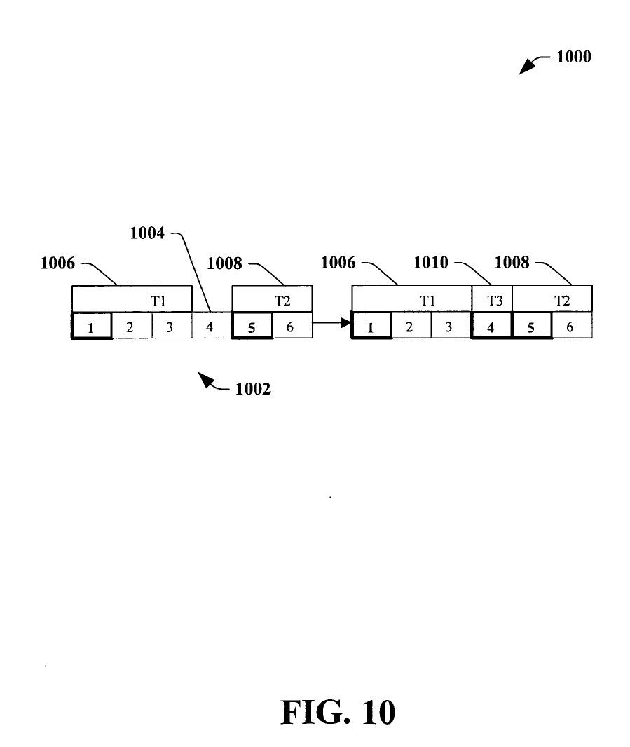

FIG. 10 illustrates a methodology 1000 that facilitates adding an audio segment to an authored video that has existing soundtrack and having at least one image/video segment not being associated with any audio segment. A group of image/video segments 1002 can have audio segment 1006 (with an anchor image/video segment at a first image/video segment and extending over images/video segments one to three) and audio segment 1008 (with an anchor image/video segment at a fifth image/video segment). An audio segment 1010 can be added to a fourth image/video segment 1004. By placing audio 1010 (“T3”) to start at the fourth image/video segment 1004, such image/video segment 1004 can be referred to as an anchor image/video segment. It is to be appreciated that the audio segment 1010 can be played until an anchor image/video segment is encountered (e.g., until the beginning of a fifth image/video segment since it is an anchor image/video segment).

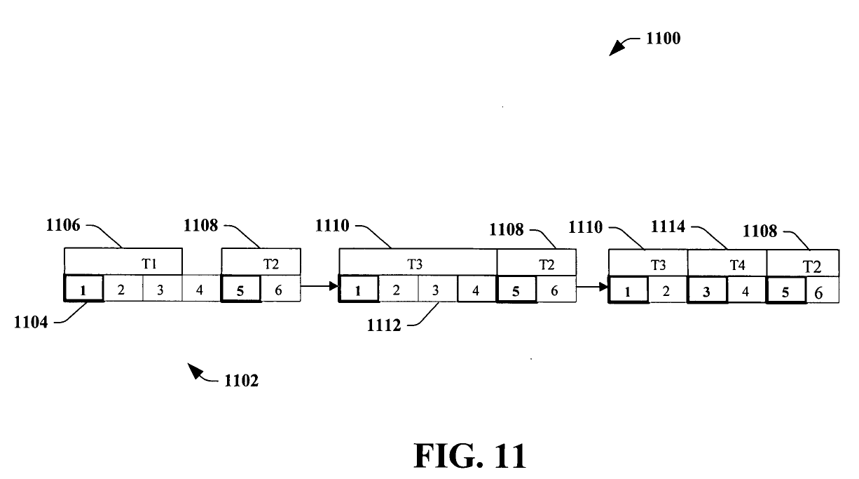

FIG. 11 illustrates a methodology 1100 that facilitates adding an audio segment to an authored video that has existing soundtrack and replacing an existing portion of the soundtrack with a longer audio segment. A group of image/video segments 1102 can have an audio segment 1106 (“T1”) associated to a first image/video segment and an audio segment 1108 (“T2”) associated to a fifth image/video segment. The audio segment 1106 can be played until an end of the audio 1106. Therefore, the audio 1106 can play over a display of a second image/video segment, and a third image/video segment. Similarly, the audio segment 1108 can be played until an end of the sixth image/video segment. A user can add an audio segment at a position 1104 (the first image/video segment). It is to be appreciated that the user can delete the audio 1106 by adding audio at an associated anchor image/video segment. By adding audio segment 1110 (“T3”) at a position 1104, the audio segment 1106 is removed/deleted. Since audio segment 1110 (“T3”) has a longer duration than the audio segment 1106 (“T1”) it replaces, its playback will extend at the end of the fourth image/video segment. It is to be appreciated that the audio segment 1010 (“T3”) can be played until an anchor image/video segment is encountered (e.g., until the beginning of a fifth image/video segment since it is an anchor image/video segment). Furthermore, the user can add an audio segment at a position 1112. The audio segment 1114 (“T4”) can start at a third image/video segment and play until an anchor image/video segment is encountered (beginning of a fifth image/video segment).

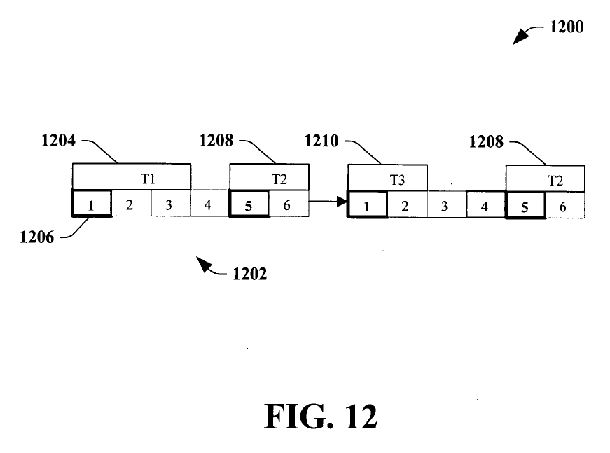

FIG. 12 illustrates a methodology 1200 that facilitates adding an audio segment to an authored video that has existing soundtrack replacing an existing portion of the soundtrack with a shorter audio segment. A group of image/video segments 1202 can have an audio segment 1204 (“T1”) (with an anchor image/video segment at a first image/video segment) and an audio segment 1208 (“T2”) (with an anchor image/video segment at a fifth image/video segment). A user can add an audio segment at a position 1206, wherein the resulting audio segment 1210 (“T3”) starts to play at a display of the first image/video segment. It is to be appreciated and understood that the audio segment 1210 can be played for a length of the audio segment 1210 and/or played until another anchor image/video segment is encountered. Since the length of the audio segment 1210 (“T3”) is shorter than that of the audio segment it replaced 1204 (“T1”), playback of images/video segments three and four will have no audio associated with them.

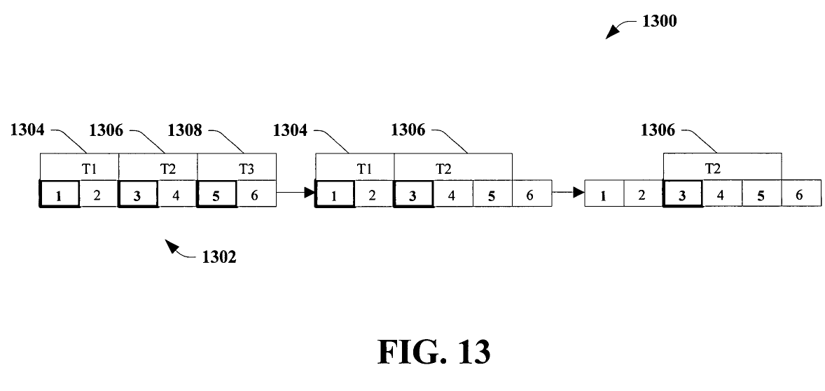

FIG. 13 illustrates a methodology 1300 that facilitates deleting an audio segment from an authored video that has existing soundtrack. A group of image/video segments 1302 can have a first audio segment 1304 (“T1”), a second audio segment 1306 (“T2”), and a third audio segment 1308 (“T3) with associated respective anchor image/video segments. A user can delete and/or remove the third audio segment 1308. For instance, after the removal of third audio segment 1308, the second audio segment 1306 can be played an entire length and extend over a fifth image/video segment since its length is long enough. Additionally, the user can remove the first audio segment 1304, which results in the authored video having the soundtrack comprised of the second audio segment 1306 starting at a third image/video segment and ending at the fifth image/video segment.

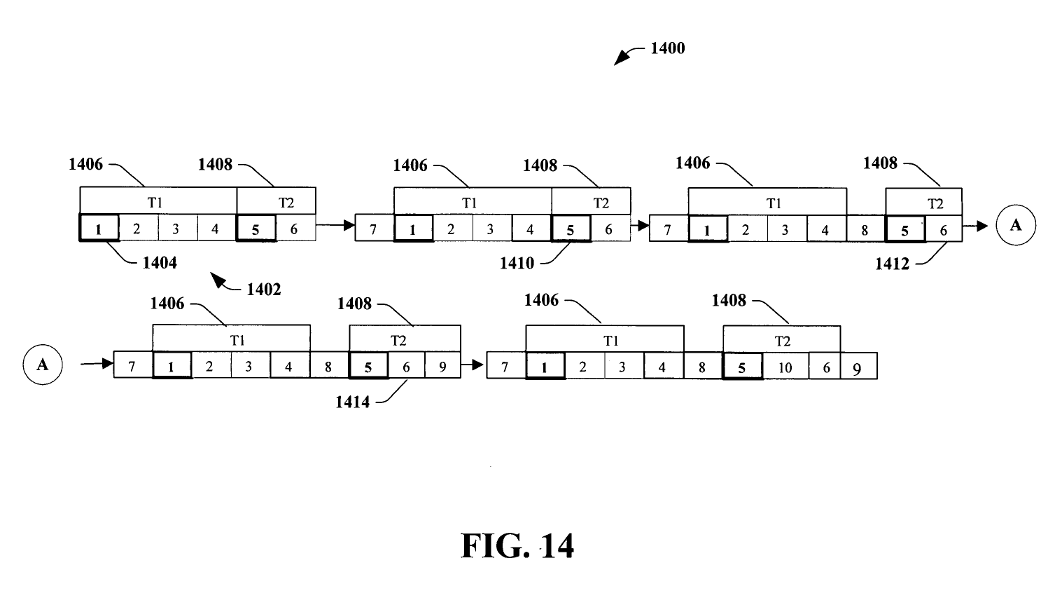

FIG. 14 illustrates a methodology 1400 that facilitates adding an image/video segment to an authored video that has existing soundtrack. A group of image/video segments 1402 can have an audio segment 1406 (“T1”) and an audio segment 1408 (“T2”). A user can add an image or a video segment (depicted as a seventh image/video segment) before a first image/video segment at position 1404. The user can also add an image or a video segment (depicted as an eighth image/video segment) before a fifth image/video segment at position 1410. It is to be appreciated that an audio segment can be associated to new image/video segments based at least in part upon whether the audio segment associated with the image/video segment preceding the newly added image/video segment has a length possible to extend over the new image/video segment. Furthermore the user can insert a ninth image/video segment after a position 1412. The audio segment 1408 can have a length capable of extending over the ninth image/video segment. Furthermore, the user can add a tenth image/video segment at position 1414, which results in the audio 1408 extending over as many images/video segment as the length can provide and therefore receding from ninth image/video segment.

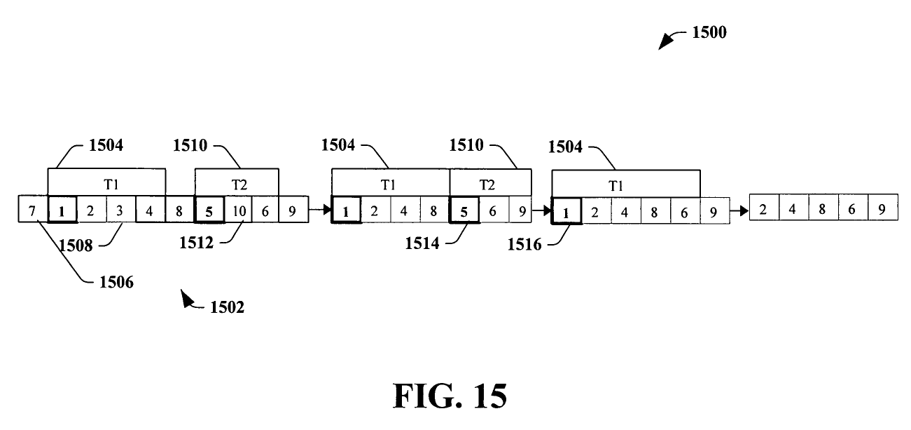

FIG. 15 illustrates a methodology 1500 that facilitates deleting an image/video segment from an authored video that has existing soundtrack. A group of image/video segments 1502 can have a first audio segment 1504 (“T1”) and a second audio segment 1510 (“T2”). A user can delete a seventh image/video segment, a third image/video segment, and a tenth image/video segment at positions 1506, 1508, and 1512, respectively. Since anchor images/video segments were not deleted, the existing audio segments are still present, their respective durations will extend to accommodate more images/video clips up to their lengths and/or until an anchor image/video segment is encountered. Moreover, the user can delete an anchor image/video segment associated to audio segment 1510 positioned at 1514, replacing both the image/video segment and the audio segment 1510. In other words, deleting the anchor image/video segment can also delete the audio segment associated thereto. For example, the user can delete a first image/video segment at position 1516, which can also delete the audio segment 1504, leaving the authored video without audio.

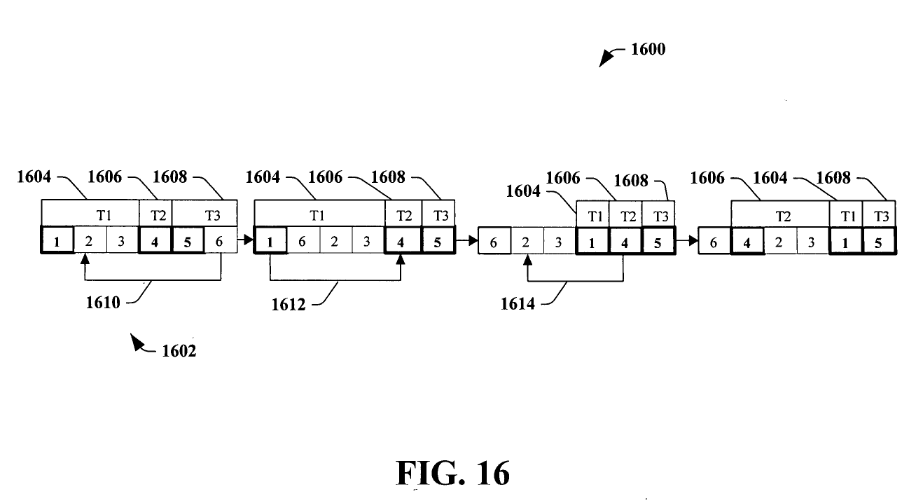

Briefly referring to FIG. 16, a methodology 1600 is illustrated that facilitates moving an image/video segment within an authored video that has existing soundtrack. It is to be appreciated that a user can move an image/video segment, wherein moving an anchor image/video segment can move an audio segment associated therewith. For instance, the user can implement a movement 1610 to a group of image/video segments 1602 having an audio segment 1604 (“T1”), an audio segment 1606 (“T2”), and an audio segment 1608 (“T3”), which places the sixth image/video segment in-between a first image/video segment and a second image/video segment. Since the sixth image/video segment is not an anchor segment, the audio segment 1604 can extend over the sixth image in its new position (e.g., if its length allows). A movement 1612 can move the first image/video segment (e.g., an anchor image/video segment for audio segment 1604) to a position in-between a third image/video segment and a fourth image/video segment. Based at least in part upon the first image/video segment being an anchor segment, the audio segment 1604 can follow the movement 1612 as illustrated. Additionally, a movement 1614 can place the fourth image/video segment to a position in-between the sixth image/video segment and a second image/video segment. It is to be appreciated that the fourth image/video segment is an anchor image/video segment and the audio segment 1606 can follow the movement 1614 of the fourth image/video segment.

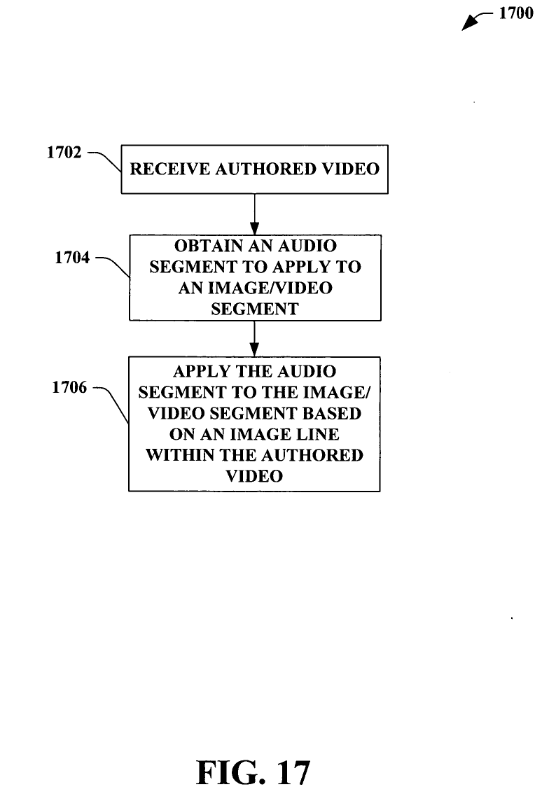

FIG. 17 illustrates a methodology 1700 that facilitates associating audio to at least one image/video segment within an authored video wherein the authored video is comprised of one or more image/video segments. At reference numeral 1702, an authored video (without audio) can be received. Audio can be created and/or provided for at least one image/video segment within the authored video, wherein an audio segment begins with an image/video segment beginning (e.g., an instance of displaying the image or video segment within the authored video). For example, a segment-line can be utilized to provide audio segment(s) to the image/video segment(s) within the authored video (e.g., a video composition comprised of sequence of short video clips and still images with panning/zooming motion associated thereto giving an impression of a video). The segment-line can be a sequence of image/video segments chronologically ordered based upon a start and an end of the image/video clip. It is to be appreciated that the audio can be applied based upon the image/video segment position by utilizing a segment-line while, conventionally, in video editing, audio is applied based upon a specific time when utilizing a timeline. It is also to be appreciated that the audio can be of any suitable format including a WAV, an MP3, an MP4, an AVI, an MPEG, a WMA,

At reference numeral 1704, audio is obtained to apply to the image/video segment within the authored video. It is to be appreciated that the audio can be created and/or existing audio, and/or any combination thereof. For instance, a user can download audio from a remote system and/or the Internet. In another example, the user can create audio by utilizing a UI that allows a selection of an instrument, a beat, a tempo, an intensity to reflect and/or convey a particular mood. Once the audio is available, it can be applied at reference numeral 1706, based at least in part upon the segment-line. As discussed earlier, the segment-line can be the sequence of image/video segments chronologically ordered based upon the start and the end of the image/video segment.

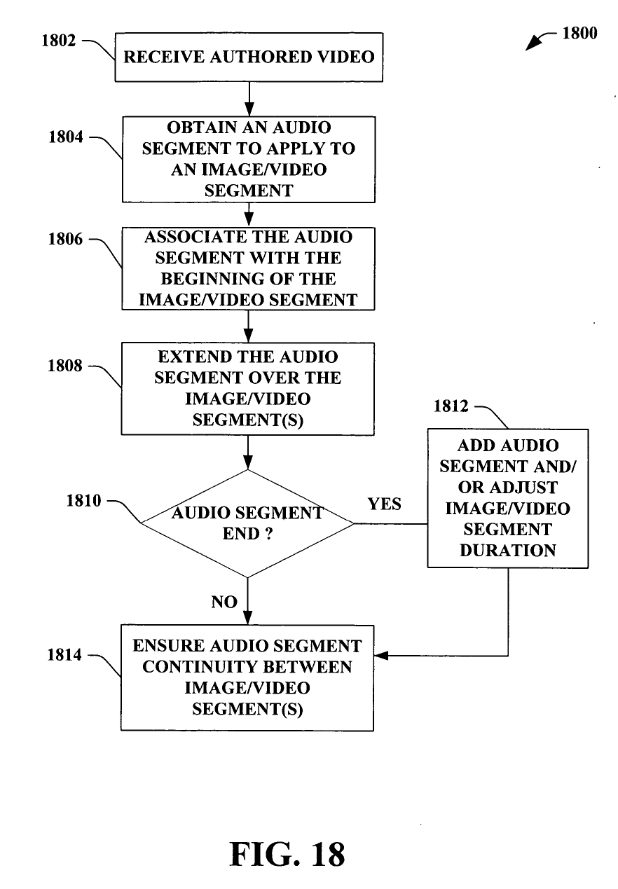

FIG. 18 is a methodology 1800 that facilitates applying audio to an image/video segment within an authored video. At reference numeral 1802, the authored video is received. An audio can be obtained at reference numeral 1804. In other words, audio can be created and/or an existing audio can be utilized. At reference numeral 1806, the audio is associated to a particular image/video segment, and can start playing at a percentage display, and/or a first display of the particular image/video segment. The audio can play and extend over as many images as a length of the audio allows and/or until an anchor image/video segment is encountered and/or end of the authored video is encountered at reference numeral 1808. Next, a determination is made as to whether the audio segment ends before an end of displaying the last image/video segment that the audio segment overlaps at reference numeral 1810. If the audio segment does end before the end of display of the last image/video segment that the audio segment overlaps, another audio segment can be added and/or duration of display for the image/video segment can be adjusted at reference numeral 1812. If the audio segment does not end before the end of display, the audio between image/video segments can be normalized to ensure audio continuity at reference numeral 1814.

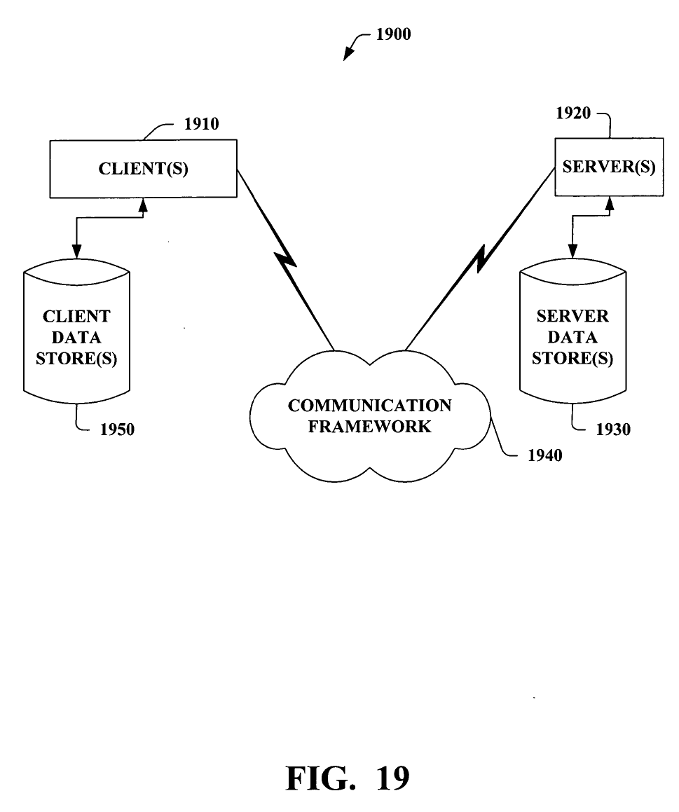

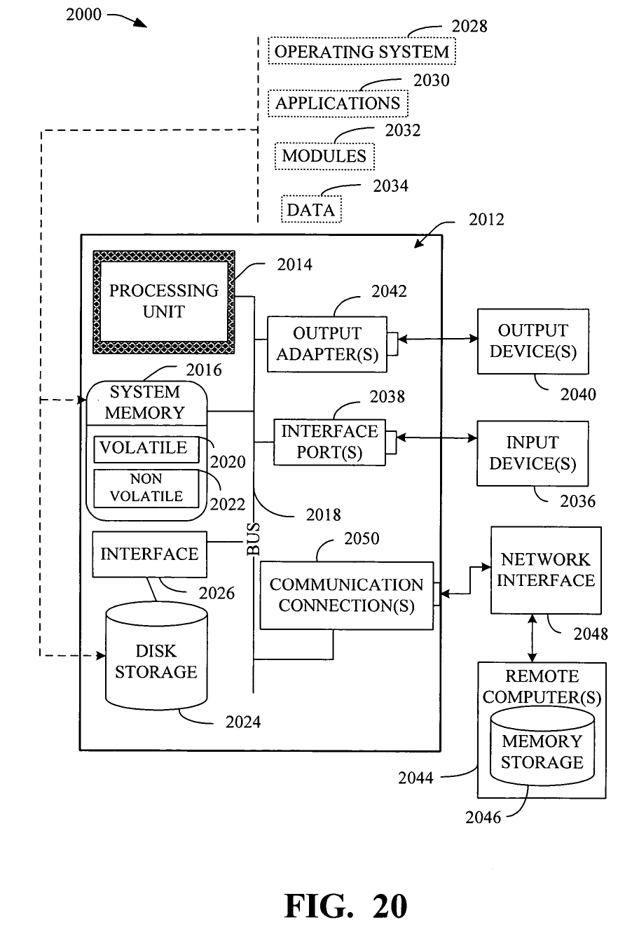

In order to provide additional context for implementing various aspects of the subject invention, FIGS. 19-20 and the following discussion is intended to provide a brief, general description of a suitable computing environment in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 19 is a schematic block diagram of a sample-computing environment 1900 with which the subject invention can interact. The system 1900 includes one or more client(s) 1910. The client(s) 1910 can be hardware and/or software (e.g., threads, processes, computing devices). The system 1900 also includes one or more server(s) 1920. The server(s) 1920 can be hardware and/or software (e.g., threads, processes, computing devices). The servers 1920 can house threads to perform transformations by employing the subject invention, for example.

One possible communication between a client 1910 and a server 1920 can be in the form of a data packet adapted to be transmitted between two or more computer processes. The system 1900 includes a communication framework 1940 that can be employed to facilitate communications between the client(s) 1910 and the server(s) 1920. The client(s) 1910 are operably connected to one or more client data store(s) 1950 that can be employed to store information local to the client(s) 1910. Similarly, the server(s) 1920 are operably connected to one or more server data store(s) 1930 that can be employed to store information local to the servers 1940.

With reference to FIG. 20, an exemplary environment 2000 for implementing various aspects of the invention includes a computer 2012. The computer 2012 includes a processing unit 2014, a system memory 2016, and a system bus 2018. The system bus 2018 couples system components including, but not limited to, the system memory 2016 to the processing unit 2014. The processing unit 2014 can be any of various available processors. Dual microprocessors and other multiprocessor architectures also can be employed as the processing unit 2014.

The system bus 2018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable programmable ROM (EEPROM), or flash memory. Volatile memory 2020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 2012 also includes removable/non-removable, volatile/non-volatile computer storage media. FIG. 20 illustrates, for example a disk storage 2024. Disk storage 2024 includes, but is not limited to, devices like a magnetic disk drive, floppy disk drive, tape drive, Jaz drive, Zip drive, LS-100 drive, flash memory card, or memory stick. In addition, disk storage 2024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2024 to the system bus 2018, a removable or non-removable interface is typically used such as interface 2026.

It is to be appreciated that FIG. 20 describes software that acts as an intermediary between users and the basic computer resources described in the suitable operating environment 2000. Such software includes an operating system 2028. Operating system 2028, which can be stored on disk storage 2024, acts to control and allocate resources of the computer system 2012. System applications 2030 take advantage of the management of resources by operating system 2028 through program modules 2032 and program data 2034 stored either in system memory 2016 or on disk storage 2024. It is to be appreciated that the subject invention can be implemented with various operating systems or combinations of operating systems.

A user enters commands or information into the computer 2012 through input device(s) 2036. Input devices 2036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2014 through the system bus 2018 via interface port(s) 2038. Interface port(s) 2038 include, for example, a serial port, a parallel port, a game port, and a universal serial bus (USB). Output device(s) 2040 use some of the same type of ports as input device(s) 2036. Thus, for example, a USB port may be used to provide input to computer 2012, and to output information from computer 2012 to an output device 2040. Output adapter 2042 is provided to illustrate that there are some output devices 2040 like monitors, speakers, and printers, among other output devices 2040, which require special adapters. The output adapters 2042 include, by way of illustration and not limitation, video and sound cards that provide a means of connection between the output device 2040 and the system bus 2018. It should be noted that other devices and/or systems of devices provide both input and output capabilities such as remote computer(s) 2044.

Computer 2012 can operate in a networked environment using logical connections to one or more remote computers, such as remote computer(s) 2044. The remote computer(s) 2044 can be a personal computer, a server, a router, a network PC, a workstation, a microprocessor based appliance, a peer device or other common network node and the like, and typically includes many or all of the elements described relative to computer 2012. For purposes of brevity, only a memory storage device 2046 is illustrated with remote computer(s) 2044. Remote computer(s) 2044 is logically connected to computer 2012 through a network interface 2048 and then physically connected via communication connection 2050. Network interface 2048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2050 refers to the hardware/software employed to connect the network interface 2048 to the bus 2018. While communication connection 2050 is shown for illustrative clarity inside computer 2012, it can also be external to computer 2012. The hardware/software necessary for connection to the network interface 2048 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates adding audio to an authored video, comprising:
a component that receives an authored video; and
an audio enhancement component that facilitates adding one or more audio segments to the authored video as a function of display of one or more image or video segments.

2. The system of claim 1, the audio segment is at least one of a user generated audio segment, and an existing audio segment, wherein the user generated audio segment is created by defining at least one of: a beat, a genre, a mood, an intensity, a selection of an instrument, a bass, a style, and a tempo.

3. The system of claim 2, the audio segment can vary a respective duration based at least in part upon an editing operation to provide audio for a beginning to an end of the video/image segment, wherein the editing operation can be at least one of an add of the video/image segment, a remove of a video/image segment, an add of an audio segment, and a remove of an audio segment.

4. The system of claim 2, further comprising an intelligent component that provides adjustment of the duration of at least one of the audio segment, and an associated video/image segment, wherein audio ends before the end of displaying the last video/image segment that the audio segment overlaps.

5. The system of claim 2, further comprising an intelligent component that provides at least one of the following: an automatic selection of one of a plurality of audio selections to be executed upon display of the image/video segment; and a probabilistic utility-based analysis relating to user preference in connection with an automatic selection.

6. The system of claim 2, the audio segment is regenerated to an updated duration as a function of an edit of the audio segment or the image/video segment such that the audio segment gives a perception of a complete musical composition with a beginning and an end related to the one or more image or video segments.

7. The system of claim 1, the audio segment is one of or a combination of a created audio and an existing audio clip.

8. The system of claim 1, the audio segment is formatted in at least one of the following: a WAV; an MP3; an MP4; an AVI; an MPEG; CDA; a WMA, and any other suitable audio format for storing digital audio.

9. The system of claim 1, further comprising a normalizer component that provides normalization for a volume level associated to at least one audio segment in relation to other audio segments in the authored video.

10. The system of claim 9, the normalizer component can provide at least one of an automatic normalization, and a manual normalization.

11. The system of claim 1, further comprising at least one of: a fade component that can provide at least one of a fade-in at a start of the audio sample and a fade-out at an end of the audio sample; or an audio transition component that provides a perception of a smooth audio transition between two subsequent audio segments.

12. The system of claim 1, the audio sample can play at a percentage of completion of a video/image transition, the transition is at least one of a wipe, a fade, a cross-fade, an explode, an implode, a matrix wipe, a push, a dissolve, a checker, and any suitable video transition of video effects and transitions.

13. A computer readable medium having stored thereon the components of the system of claim 1.

14. A computer-implemented method that facilitates playing audio associated to an authored video, comprising:
receiving the authored video;
obtaining audio to be associated with an image/video segment; and
adding the audio to the video so as to be executed at display of the image/video segment.

15. The method of claim 14, further comprising at least one of:
extending the audio segment until at least one of an entire length of the audio segment, an end of the authored video, and an encounter with an image/video segment with an audio segment to start playing at the display of such image/video segment;
normalizing the volume of the audio segment to ensure continuity;
determining if the audio segment ends before a display of the last image/video segment that it overlaps is complete;
adjusting duration of the audio segment to ensure that the audio segment plays until the display of the last image/video segment that it overlaps is complete; and
adjusting an image/video segment duration to match a length of the audio segment.

16. The method of claim 14, further comprising at least one of:
applying a fade-in at a start of the audio segment;
applying a fade-out at an end of the audio segment;
applying the audio segment at a percentage of completion of a image/video transition; and
applying an audio transition between subsequent audio segments to provide perception of a smooth audio transition between audio segments.

17. The method of claim 14, further comprising at least one of:
adding an audio segment;
deleting the audio segment;
adding an image/video segment;
deleting an image/video segment;
moving an image/video segment; and
adjusting the duration of an image/video segment

18. The method of claim 14, further comprising at least one of creating and utilizing an audio segment and utilizing an existing audio segment.

19. A data packet that communicates between a receiver component and the audio enhancement component, the data packet facilitates the method of claim 14.

20. A computer-implemented system that facilitates playing audio associated to an authored video, comprising:
means for receiving the authored video that has at least one image/video segment; and
means for applying an audio segment to the authored video that can play based at least in part upon a start of a display of the associated image/video segment.
